(19) United States
(12) Patent Application Publication
(10) Pub. No.: US 2016/0070052 A1
(43) Pub. Date: Mar. 10, 2016

(54) LIGHT GUIDE BODY AND PLANAR LIGHT-EMISSION DEVICE PROVIDED WITH SAME

(71) Applicant: SHARP KABUSHIKI KAISHA, Osaka (JP)

(72) Inventor: Junichi MASUDA, Osaka-shi (JP)

(21) Appl. No.: 14/786,279

(22) PCT Filed: Mar. 3, 2014
(86) PCT No.: PCT/JP2014/055303

§ 371 Date: Oct. 22, 2015

(30) Foreign Application Priority Data
Jun. 10, 2013 (JP) 2013-121945

(51) Int. Cl. F21V 8/00

(52) U.S. Cl. CPC G02B 6/0043; G02B 6/0041; G02B 6/0051

(57) ABSTRACT

An object is to provide a light guide body that is able to obtain a large amount of emission light perpendicular to a light emission surface and achieve uniform surface emission with an inexpensive structure. To attain this object, a light guide plate has, on at least one of a light emission surface and a back surface facing the light emission surface, a light diffusion pattern formed of a plurality of dots containing a first diffusing agent and the light diffusion pattern is controlled by the size of the dots and the density of the dots.

### TECHNICAL FIELD

The present invention relates to a light guide body that is used in a planar light-emission device.

### BACKGROUND ART

Conventionally, as a planar light-emission device that is used as, for example, a backlight of a liquid crystal display device, there have been a direct type provided with a light source directly below a light guide plate (a light guide body) and an edge type provided with a light source on a side of a light guide plate. In general, from the viewpoint of reducing the structural components and achieving a reduction in weight and thickness, for example, the edge type is often adopted.

In the edge-type planar light-emission device, light from the light source is made to enter the light guide plate and the incident light repeats total reflection inside the light guide plate, is reflected from a fluorescent ink, a lens shape, and the like which are provided on a back surface (a reflective surface facing a light emission surface) of the light guide plate, and emits from the light emission surface, whereby surface emission is achieved. However, since the light emitting from the light guide plate is refracted by Fresnel's law and most of the light emits at an angle which is almost parallel to the light emission surface of the light guide plate, a large amount of emission light perpendicular to the light emission surface may not be obtained.

As measures against this, a technique of providing an optical sheet on the light emission surface side of the light guide plate or a technique of adding a diffusing agent to the light guide plate is used. However, if the optical sheet is used, the number of parts is increased, which increases the material cost and the assembly cost. On the other hand, if the diffusing agent is used, it is difficult to adjust the concentration of the diffusing agent inside of the light guide plate, which makes it difficult to achieve uniform surface emission. The diffusing agent usually diffuses uniformly inside of the light guide plate and it becomes the brightest near the light source and becomes darker with distance from the light source, making it unable to achieve uniform surface emission.

Incidentally, PTL 1 discloses a structure in which light diffusion dots are formed on at least one surface of a light guide plate and two or more types of light diffusion dots having different sizes are irregularly arranged in a region in which the masking rate by the light diffusion dots is 50% or less. Moreover, PTL 2 discloses a light guide plate formed by stacking light guide layers with different concentrations of diffusing agent in such a way as to provide gradations in thickness.

### CITATION LIST

### Patent Literature

PTL 1: Japanese Unexamined Patent Application Publication No. 2012-151100

PTL 2: Japanese Unexamined Patent Application Publication No. 2013-20796

### SUMMARY OF INVENTION

### Technical Problem

However, with the technique of PTL 1, a large amount of emission light perpendicular to the light emission surface of the light guide plate may not be obtained. Moreover, with the technique of PTL 2, since a plurality of light guide layers with different concentrations of diffusing agent are desired, many materials are demanded, which results in an increase in price. Furthermore, it is desired to make the layers stick together completely, which makes production difficult.

An object of the present invention is to provide a light guide body that is able to obtain a large amount of emission light perpendicular to a light emission surface and is able to achieve uniform surface emission with an inexpensive structure. Moreover, another object is to provide a planar light-emission device provided with such a light guide body.

### Solution to Problem

To attain the above-described objects, a light guide body of the present invention includes a light diffusion pattern formed of a plurality of dots or lines containing a first diffusing agent on at least one of a light emission surface and a back surface facing the light emission surface and the light diffusion pattern is controlled by a size of the dots or a width of the lines and a density of the dots or the lines.

### Effects of Invention

According to the present invention, a light diffusion pattern containing a first diffusing agent makes it possible to obtain a large amount of emission light perpendicular to a light emission surface with an inexpensive structure. Moreover, by controlling the light diffusion pattern by the size of dots or the width of lines and the density of the dots or the lines, it is possible to achieve uniform surface emission. For example, a high level of luminance distribution desired for a liquid crystal display device is able to be achieved. By using such a light guide body, an optical-sheetless or the number of optical sheets is abler to be reduced. In addition, as a result of the number of parts being reduced, the material cost and the assembly cost are able to be reduced. Furthermore, it is possible to curb various problems which arise due to the use of an optical sheet, such as variations in the optical sheet and a warp in the optical sheet.

### BRIEF DESCRIPTION OF DRAWINGS

FIG. 1 is a plan view of a planar light-emission device of a first embodiment of the present invention.

FIG. 2 is a sectional view taken on the line A-A of FIG. 1.

FIG. 3 is a plan view of a light guide plate of the first embodiment of the present invention.

FIG. 4 is a diagram explaining an example of the luminance distribution of the light guide plate of the first embodiment of the present invention.

FIG. 5 is a diagram explaining an example of the luminance distribution of the light guide plate of the first embodiment of the present invention.

FIG. 6 is a diagram explaining an example of the luminance distribution of the light guide plate of the first embodiment of the present invention.

FIG. 7 is a partial sectional view of a planar light-emission device of a third embodiment of the present invention.

### DESCRIPTION OF EMBODIMENTS

Hereinafter, embodiments of the present invention will be described with reference to the drawings. In the following embodiments, descriptions will be given by taking up a backlight of a liquid crystal display device as an example of a planar light-emission device. Incidentally, the planar light-emission device of the present invention may be used also in display devices adopting other optical shutter devices such as MEMS (micro electro mechanical systems) and the like. Structural components shared by the embodiments will be identified with the same reference characters and overlapping explanations will be omitted. Moreover, the technical features described in the embodiments may be implemented by appropriately combining within the workable scope.

### First Embodiment

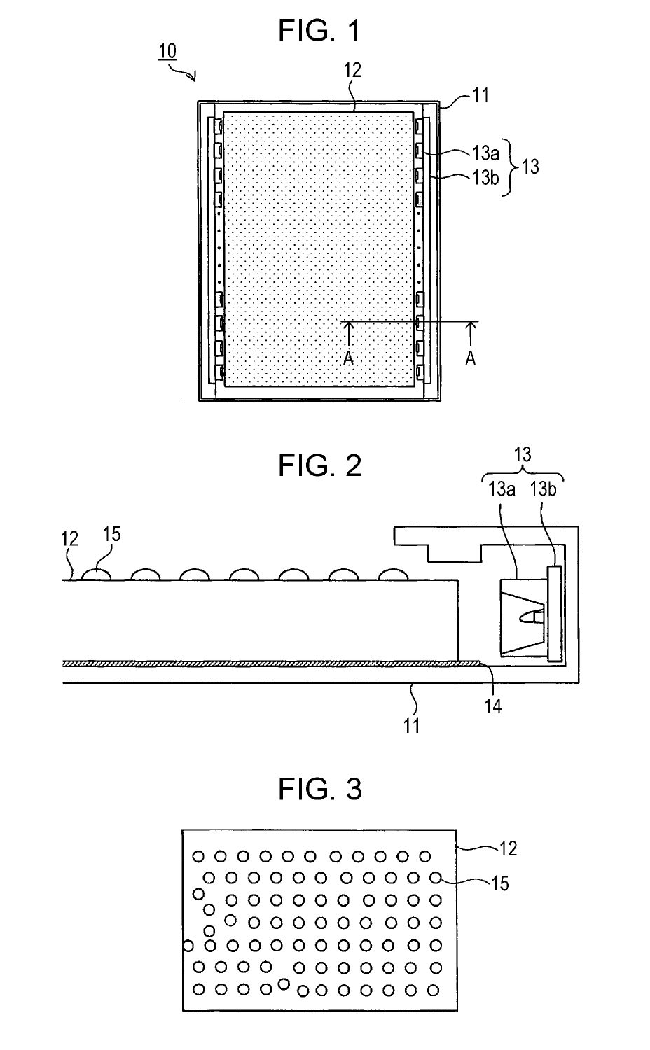

FIG. 1 is a plan view of a planar light-emission device of this embodiment, FIG. 2 is a sectional view taken on the line A-A of FIG. 1, and FIG. 3 is a plan view of a light guide plate of this embodiment.

A planar light-emission device 10 includes a backlight chassis 11, a light guide plate (a light guide body) 12, a light source unit 13, and a reflective sheet 14. Incidentally, various kinds of optical sheets may be appropriately provided on the light guide plate 12. The optical sheet is a generic name for a prism sheet, a diffusion sheet, and the like and is any one sheet of these sheets or a combination of a plurality of sheets of these sheets.

The backlight chassis 11 is a structural component serving as a base for mounting (accommodating) the structural components of the planar light-emission device 10. It is desirable to use, as the material of the backlight chassis 11, SECC (steel plate), aluminum, or the like in order to ensure stiffness and thermal dissipation.

The light guide plate 12 is a structural component that converts the light incident from a light incident surface into a surface light source and makes it exit from a light emission surface. The light guide plate 12 is a rectangular parallelepiped, for example, and has a light emission surface facing a liquid crystal panel (not depicted in the drawing), a surface (a back surface) facing the light emission surface, and four side faces connecting these two faces. Of the four side faces, two side faces (in FIG. 1, two faces located on the long sides) are light incident surfaces facing each light source unit 13. Incidentally, the light incident surface only has to be at least one side face and it is only desirable to provide the light source unit 13 whose number corresponds to the number of light incident surfaces which the light source units 13 face. As the material of the light guide plate 12, from the viewpoint of achieving a reduction in thickness and weight, it is desirable to use resin such as acrylic, polystyrene or PC (polycarbonate), or glass.

The light source unit 13 is placed so as to face the light incident surface of the light guide plate 12. Such a placement of the light source unit 13 is called an edge type, which is able to achieve a further reduction in thickness than a direct type. The light source unit 13 includes an LED (light emitting diode) 13a which is a point light source and an LED substrate 13b on which the LED is mounted. Then, a plurality of LEDs 13a are placed on the LED substrate 13b at predetermined intervals along a side face of the light guide plate 12 and thereby form a linear light source. As the LED substrate 13b, in consideration of thermal dissipation and strength, it is desirable to use a metal substrate such as Al. Incidentally, as the light source, in addition to the LED, a fluorescent tube which is a linear light source, for example, may be used.

The reflective sheet 14 is placed on the side (the back surface side) facing the light emission surface of the light guide plate 12. The light that has reached the back surface inside the light guide plate 12 is reflected by the reflective sheet 14, whereby the light emission efficiency of the light guide plate 12 is enhanced.

Next, a characteristic structure of this embodiment will be described. The light guide plate 12 has, on the light emission surface, a light diffusion pattern formed of a plurality of dots 15 containing a first diffusing agent. This light diffusion pattern is controlled (determined) by the size of the dots 15 and the density of the dots 15 so as to be able to achieve uniform surface emission. The angle at which the light inside the light guide plate 12 propagates varies depending on the dot 15, and the light having a smaller angular component than a critical angle is extracted from the light emission surface.

The dots 15 enhance the light extraction efficiency by mainly reflecting the light inside the light guide plate 12 and dispersing the light. The dots 15 may have a circular shape, for example, and are formed by, for example, performing inkjet printing or the like by using white paint containing the first diffusing agent. Incidentally, the shape of the dots 15 is not limited to a particular shape and the dots 15 may have an elliptical or polygonal shape. The shape becomes hemispherical in the case of inkjet printing, but any shape may be obtained by using screen printing or the like.

The material, shape, and the like of the first diffusing agent are not limited to particular material, shape, and the like as long as the first diffusing agent diffuses light, and, for example, minute silica beads may be used. In addition thereto, fine particles of silicone, zirconia, titanium dioxide, calcium carbonate, and so forth may also be used. Moreover, the degree of dispersion may be adjusted by adjusting the concentration of the first diffusing agent in the light diffusion pattern.

As described earlier, the light diffusion pattern is determined by the size of the dots 15 and the density of the dots 15; the shorter the distance between the dots 15 is, that is, the higher the density of the dots 15 is, the more precise adjustment of luminance distribution becomes possible. For example, it is desirable that the distance between the dots 15 is 100 μm or less. Moreover, if the size of the dots 15 is too large, the precise adjustment of luminance distribution may not be achieved and, if the size of the dots 15 is too small, it becomes difficult to achieve the effect of light diffusion; therefore, it is desirable that the size of the dots 15 is 50 to 80 μm.

Furthermore, the light diffusion pattern may have a shape other than the dots 15 and, for example, may be lines (each being a line having a width) such as stripes or curved lines. If such lines are used, the light diffusion pattern is controlled by the width of the lines and the density of the lines. In addition, as similar to the case where the dots 15 are used, by shortening the distance between the lines and setting the width of the lines within an appropriate range, it is possible to adjust luminance distribution precisely.

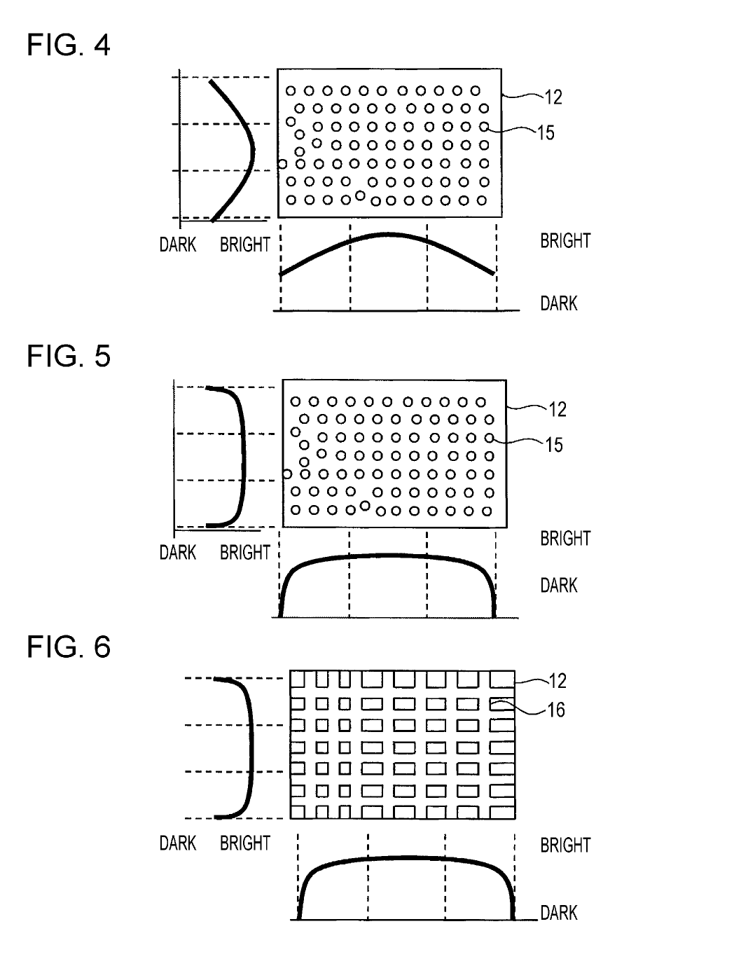

FIGS. 4 to 6 are diagrams, each explaining an example of the luminance distribution of the light guide plate of this embodiment. The light guide plate 12 depicted in FIG. 4 has a light diffusion pattern formed of the dots 15 and, in both the lengthwise direction and the widthwise direction, the luminance near the center is the highest and the luminance is gradually lowered from the center toward both ends. In addition, a difference between the luminance near the center and the luminance near both ends is within 20%. Such luminance distribution satisfies a high level of luminance distribution desirable for a liquid crystal display device.

The light guide plate 12 depicted in FIG. 5 has a light diffusion pattern formed of the dots 15 and, in both the lengthwise direction and the widthwise direction, the luminance near the center is the highest, the luminance is slightly lowered from the center toward both ends, and the luminance is sharply lowered near both ends. In addition, a difference between the luminance near the center and the luminance near both ends is within 20%. Such luminance distribution also satisfies a high level of luminance distribution desirable for the liquid crystal display device.

The light guide plate 12 depicted in FIG. 6 has a light diffusion pattern formed of stripe-shaped lines 16 intersecting lengthwise and widthwise at right angles and has the same luminance distribution as FIG. 5. A high level of luminance distribution desirable for the liquid crystal display device may also be obtained by such light diffusion pattern.

Incidentally, in this embodiment, the same effect may be obtained even when the light diffusion pattern is provided on the back surface of the light guide plate 12. Moreover, the light diffusion pattern may be provided on both the light emission surface and the back surface. That is, the light diffusion pattern only has to be formed on at least one of the light emission surface and the back surface facing the light emission surface of the light guide plate 12.

As described above, the light guide plate 12 of this embodiment has, on at least one of the light emission surface and the back surface facing the light emission surface, the light diffusion pattern formed of the plurality of dots 15 or lines 16 containing the first diffusing agent, and the light diffusion pattern is controlled by the size of the dots 15 or the width of the lines 16 and the density of the dots 15 or the lines 16.

According to this embodiment, the light diffusion pattern containing the first diffusing agent makes it possible to obtain a large amount of emission light perpendicular to the light emission surface with an inexpensive structure. Moreover, by controlling the light diffusion pattern by the size of the dots 15 or the width of the lines 16 and the density of the dots 15 or the lines 16, it is possible to achieve uniform surface emission. For example, it is possible to achieve a high level of luminance distribution desirable for the liquid crystal display device. By using such a light guide plate 12, it is possible to achieve an optical-sheetless or reduce the number of optical sheets. In addition, as a result of the number of parts being reduced, it is possible to reduce the material cost and the assembly cost. Furthermore, it is possible to curb various problems which arise due to the use of an optical sheet, such as variations in the optical sheet and a warp in the optical sheet.

### Second Embodiment

A second embodiment is obtained by modifying the first embodiment such that the light guide plate 12 other than the light diffusion pattern contains a second diffusing agent. The other structures are the same as the first embodiment.

As is the case with the first diffusing agent, the material, shape, and the like of the second diffusing agent are not limited to particular material, shape, and the like as long as the second diffusing agent diffuses light, and, for example, minute silica beads may be used. In addition thereto, the same fine particles as the first diffusing agent may also be used. Moreover, the degree of dispersion may be adjusted by adjusting the concentration of the second diffusing agent in the light guide plate 12. Furthermore, it is only desirable to disperse the second diffusing agent uniformly in the light guide plate 12, and it is not desirable to make adjustments to vary the concentration of the diffusing agent in the light guide plate 12. Therefore, the light guide plate 12 to which the second diffusing agent is added may be produced easily at low cost.

As described above, as a result of the second diffusing agent being added to the light guide plate 12, the light that propagates through the light guide plate 12 is dispersed by the second diffusing agent. As a result, the light perpendicular to the light emission surface increases and a larger amount of emission light perpendicular to the light emission surface may be obtained. At this time, since the emission light from the space in the light diffusion pattern increases on the light emission surface, the luminance difference between the emission light from the space in the light diffusion pattern and the emission light from the light diffusion pattern is reduced and display quality is improved.

Moreover, the concentration of the first diffusing agent in the light diffusion pattern and the concentration of the second diffusing agent in the light guide plate 12 are independently adjusted so as to achieve uniform surface emission. At this time, it is desirable that the concentration of the second diffusing agent is a concentration at which the light from the LEDs 13a propagates through the whole light guide plate 12; on the other hand, it is desirable that the concentration of the first diffusing agent is a concentration at which uniform surface emission is able to be achieved by the light diffusion pattern with the light extraction efficiency being enhanced.

There are several conditions for achieving uniform surface emission with regard to the concentrations of the first and second diffusing agents, the placement of the light diffusion pattern, and so forth. Of these conditions, it is desirable that the concentration of the first diffusing agent in the light diffusion pattern is higher than or equal to the concentration of the second diffusing agent in the light guide plate 12 and a concentration difference therebetween is small. Specifically, the concentration of the first diffusing agent in the light diffusion pattern is desirably 1 time or more but 1.1 times or less and more desirably 1 time or more but 1.05 times or less the concentration of the second diffusing agent in the light guide plate 12.

If the above-described concentration difference is large, the amount of the emission light from the light diffusion pattern is large and the light diffusion pattern easily becomes a bright spot; however, by reducing the concentration difference therebetween, the luminance difference between the emission light from the space in the light diffusion pattern and the emission light from the light diffusion pattern is reduced on the light emission surface and a bright spot does not appear easily, which results in a high degree of uniformity in luminance and enhanced display quality.

### Third Embodiment

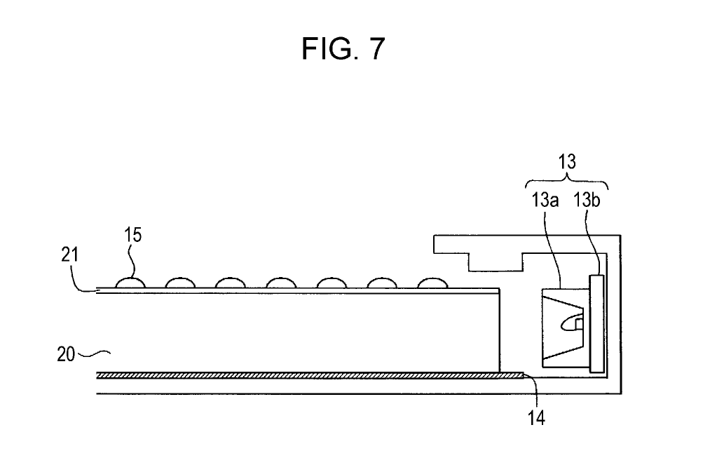

FIG. 7 is a partial sectional view of a planar light-emission device of this embodiment. As depicted in FIG. 7, the third embodiment differs from the first embodiment in that a film 21 with a light diffusion pattern is used. The other structures are the same as the first embodiment.

A light guide plate 20 is formed to have the film 21 with a light diffusion pattern attached, with an adhesive or the like, to the side of the light guide plate 20 where a light emission surface is located. The main body of the light guide plate 20 other than the film 21 may be formed by using the same material as the light guide plate 12 of the first embodiment. As the material of the film 21, a material that is usable for the light guide plate 20 may be used. In addition, from the viewpoint of enhancing the light extraction efficiency, it is desirable that the refractive index of the film 21 is almost equal to the refractive index of the main body of the light guide plate 20. Thus, it is desirable to use the same material for the film 21 and the light guide plate 20.

The light diffusion pattern may be similar to that of the first embodiment, and, for example, in FIG. 7, the dots 15 are adopted. Moreover, as in the second embodiment, the second diffusing agent may be added to the light guide plate 20.

Incidentally, in this embodiment, the same effect may be obtained even when the film 21 is provided on the back surface of the light guide plate 20. Moreover, the film 21 may be provided on both the light emission surface and the back surface. That is, the film 21 only has to be provided on at least one of the light emission surface of the light guide plate 20 and the back surface facing the light emission surface.

As described above, by forming the light diffusion pattern on the film 21, it is possible to perform roll-to-roll printing of the light diffusion pattern on the film, which increases the production speed as compared to a case where direct printing is performed on the light guide plate. In addition, it becomes easy to process the light diffusion pattern into a large area film 21, which makes it easy to support screens which are getting larger and larger.

The following is a short description of the embodiments of the present invention. A light guide body (a light guide plate 12) of an embodiment of the present invention has, on at least one of a light emission surface and a back surface facing the light emission surface, a light diffusion pattern formed of a plurality of dots 15 or lines 16 containing a first diffusing agent, and the light diffusion pattern is controlled by the size of the dots 15 or the width of the lines 16 and the density of the dots 15 or the lines 16.

With this structure, the light diffusion pattern containing the first diffusing agent makes it possible to obtain a large amount of emission light perpendicular to the light emission surface with an inexpensive structure. Moreover, by controlling the light diffusion pattern by the size of the dots 15 and the width of the lines 16 and the density of the dots 15 or the lines 16, it is possible to achieve uniform surface emission. For example, a high level of luminance distribution desirable for a liquid crystal display device may be achieved. By using such a light guide body (light guide plate 12), an optical-sheetless or the number of optical sheets may be reduced. In addition, as a result of the number of parts being reduced, the material cost and the assembly cost may be reduced. Furthermore, it is possible to curb various problems which arise due to the use of an optical sheet, such as variations in the optical sheet and a warp in the optical sheet.

In the above-described light guide body, it is desirable that the light guide body other than the light diffusion pattern contains a second diffusing agent.

With this structure, it is only desired to disperse the second diffusing agent uniformly in the light guide body, and adjustments do not have be performed to vary the concentration of the diffusing agent in the light guide body. Therefore, the light guide body to which the second diffusing agent is added may be produced easily at low cost. Moreover, as a result of the second diffusing agent being added to the light guide body, the light that propagates through the light guide body is dispersed by the second diffusing agent. As a result, the light perpendicular to the light emission surface increases and a larger amount of emission light perpendicular to the light emission surface may be obtained. At this time, since the emission light from the space in the light diffusion pattern increases on the light emission surface, the luminance difference between the emission light from the space in the light diffusion pattern and the emission light from the light diffusion pattern is reduced and display quality is improved.

Moreover, in the above-described light guide body, it is desirable that the concentration of the first diffusing agent in the light diffusion pattern is 1 time or more but 1.1 times or less the concentration of the second diffusing agent in the light guide body.

With this structure, the luminance difference between the emission light from the space in the light diffusion pattern and the emission light from the light diffusion pattern is reduced on the light emission surface and a bright spot does not appear easily, which results in a high degree of uniformity in luminance and enhanced display quality.

Moreover, the above-described light guide body may have a structure in which a film 21 having the light diffusion pattern is attached to the light guide body.

With this structure, by forming the light diffusion pattern on the film 21, it is possible to perform roll-to-roll printing of the light diffusion pattern on the film 21, which increases the production speed as compared to a case where direct printing is performed on the light guide body. In addition, it becomes easy to process the light diffusion pattern into a large area film 21, which makes it easy to support screens which are getting larger and larger.

Furthermore, a planar light-emission device 10 of an embodiment of the present invention includes the light guide body mentioned in any description above, the light guide body using one side face other than the light emission surface and the back surface as a light incident surface, and a light source (an LED 13a) facing the light incident surface.

With this structure, it is possible to provide an edge-type planar light-emission device that is capable of using as a backlight a liquid crystal display device and so forth.

### INDUSTRIAL APPLICABILITY

The present invention may be used in a display device that adopts a liquid crystal panel or an optical shutter device such as MEMS.

### REFERENCE SIGNS LIST

10 planar light-emission device
12 light guide plate (light guide body)
13a LED (light source)
15 dot
16 line
21 film

1. A light guide body comprising:
a light diffusion pattern formed of a plurality of dots or lines containing a first diffusing agent on at least one of a light emission surface and a back surface facing the light emission surface, wherein
the light guide body other than the light diffusion pattern contains a second diffusing agent,
a concentration of the first diffusing agent in the light diffusion pattern is equal to or higher than a concentration of the second diffusing agent in the light guide body, and
the light diffusion pattern is controlled by a size of the dots or a width of the lines and a density of the dots or the lines.

2. (canceled)

3. The light guide body according to claim 1, wherein
a concentration of the first diffusing agent in the light diffusion pattern is 1 time or more but 1.1 times or less a concentration of the second diffusing agent in the light guide body.

4. The light guide body according to claim 1, wherein
a film having the light diffusion pattern is attached to the light guide body.

5. A planar light-emission device comprising:
the light guide body according to claim 1, the light guide body using one side face other than the light emission surface and the back surface as a light incident surface; and
a light source facing the light incident surface

6. The light guide body according to claim 3, wherein
the concentration of the first diffusing agent in the light diffusion pattern is 1 time or more but 1.05 times or less the concentration of the second diffusing agent in the light guide body.
